(19) United States
(12) Patent Application Publication
(10) Pub. No.: US 2025/0182959 A1
(43) Pub. Date: Jun. 5, 2025

(54) OPTICALLY INDICATING THERMAL ADVISORY

(71) Applicant: Hubbell Incorporated, Shelton, CT (US)

(72) Inventors: Mark William Sommer, Concord, NC (US); Daniel Eric Huenger, West Henrietta, NY (US); Eric Ralph Weatherbee, Attica, NY (US); Shibao Zhang, Pittsford, NY (US)

(21) Appl. No.: 18/965,383

(22) Filed: Dec. 2, 2024

Related U.S. Application Data
(60) Provisional application No. 63/605,781, filed on Dec. 4, 2023.

(51) Int. Cl. H01F 27/40; G01K 1/024; G01K 11/06; G01K 11/12; G01K 15/00; H01F 27/04

(52) U.S. Cl. CPC H01F 27/402; G01K 1/024; G01K 11/06; G01K 11/12; G01K 15/005; H01F 27/04; H01F 2027/406

(57) ABSTRACT

An electrical bushing that provides an alert to a system condition that includes a body and a thermochromic paint. The body has an internal surface that can receive an electrical device and an external surface. The thermochromic paint is applied to the external surface of the body. The thermochromic paint includes a first color at a first temperature and can change to a second color when the body reaches a second temperature. The second color provides a visual alert for a fault in the body.

### CROSS-REFERENCE TO RELATED APPLICATION

This application claims the benefit of U.S. Provisional Application No. 63/605,781, filed Dec. 4, 2023, the entire contents of which is incorporated by reference herein in its entirety.

### FIELD

The present invention relates to a method for monitoring temperatures seen on electrical bushings. More specifically the invention relates to a bushing which utilizes an observable optical change that can be observed to indicate a temperature has occurred on the bushing which exceeds predetermined limits.

### BACKGROUND

Electricity is typically moved through the power systems at voltages up to 1000 kV. To move the electricity through grounded interfaces, bushings are utilized to transfer the electricity into devices such as power transformers. The bushing acts as the means to isolate electricity from the grounded interface it is traversing through. As bushings are isolating voltages from ground potential they will be under great amounts of electrical stress and the insulation will be vulnerable to thermal degradation.

Not only are bushings acting as the insulation between electricity and ground they also act as the connection point between devices and power lines. These connections if either initially loose or if loosened over time can cause high temperature to occur at the bushing causing damage to the insulation materials of the bushing or to seals of the bushing or connected apparatus. Loose connections can also lead to the electrical failure of the insulation.

The bushings may be installed in positions not easily observable by humans. For example, the bushings may be high above the ground and/or disposed in an obstructed location where the connection is not easily observable. Additionally, the connection point between the devices and power lines may be internal to the bushing, and a loose connection may not be readily visible even if the bushing is in the line of sight of a person.

### SUMMARY

Various embodiments of the present disclosure can overcome various of the aforementioned and other disadvantages associated with known bushings and other connectors and offer new advantages as well.

According to one aspect of various embodiments of the present disclosure there is provided connector which can be visually inspected to garner if the equipment underwent any thermal event that can damaged and/or degraded the insulation or seals of the connector.

According to another aspect of various embodiments of the present disclosure, there is provided a diagnostic measure that can be used in the event of equipment failure via a visual indicator that can help in evaluations to help determine if heat was a causal factor.

According to one aspect of various embodiments of the present disclosure there is provided an electrical bushing having an external surface coated with a thermochromic paint that can be calibrated to indicate an inappropriate temperature is occurring at that surface.

According to one aspect of various embodiments of the present disclosure there is provided an electrical connector having an external surface treated with a coating that undergoes an irreversible color change when a temperature of the connector exceeds a predetermined threshold.

According to one aspect of various embodiments of the present disclosure there is provided an electrical connector having an external surface treated with a coating that undergoes a reversible color change when a temperature of the connector exceeds a predetermined threshold.

According to one aspect of various embodiments of the present disclosure there is provided a connector that can output an alert communicating an inappropriate temperature condition at its surface. The output may be visual, auditory, and/or electronic.

According to one aspect of various embodiments of the present disclosure there is provided an electrical bushing that provides an alert to a system condition that includes a body and a thermochromic paint. The body has an internal surface that can receive an electrical device and an external surface. The thermochromic paint is applied to the external surface of the body. The thermochromic paint includes a first color at a first temperature and can change to a second color when the body reaches a second temperature. The second color provides a visual alert for a fault in the body.

According to one aspect of various embodiments of the present disclosure there is provided an electrical connector for providing an alert to a system condition. The electrical connector includes a body and a thermochromic paint. The body can be coupled to an electrical device. The thermochromic paint can be applied to a surface of the body. The thermochromic paint includes a first color at a first temperature and can change to a second color when the body reaches a second temperature. The second color provides a visual alert for a fault in the body.

According to one aspect of various embodiments of the present disclosure there is provided an electrical connector that provides an alert to a system condition that includes a body and a thermochromic paint. The body is an insulating body for isolating voltage from a mounted surface. The body has an internal surface that can receive an electrical device and an internal surface. The thermochromic paint is applied to the external surface of the body. The thermochromic paint includes a first color at a first temperature and can change to a second color when the body reaches a second temperature. The second color provides a visual alert for a fault in the body.

According to one aspect of various embodiments of the present disclosure there is provided an electrical bushing that provides an alert to a system condition that includes a body and a thermochromic paint. The body is an insulating body for isolating voltage from a mounted surface. The body has an internal surface that can receive an electrical device and an external surface. The thermochromic paint is applied to the external surface of the body. The thermochromic paint includes a first color at a first temperature and can change to a second color when the body reaches a second temperature. The second color provides a visual alert for a fault in the body.

According to one aspect of various embodiments of the present disclosure there is provided an electrical connector that provides an alert to a system condition that includes a body and a thermochromic paint. The body is an insulating body for isolating voltage from a mounted surface. The body has an internal surface that can receive an electrical device and an external surface. The thermochromic paint is applied to the external surface of the body. The thermochromic paint includes a first color at a first temperature and can change to a second color when the body reaches a second temperature. The second color provides a visual alert for a fault in the body.

According to one aspect of various embodiments of the present disclosure there is provided a power system that includes a first electrical device, a second electrical device, and an electrical bushing. The electrical bushing that provides an alert to a system condition that includes a body and a thermochromic paint. The body has an internal surface that can receive an electrical device and an external surface. The thermochromic paint is applied to the external surface of the body. The thermochromic paint includes a first color at a first temperature and can change to a second color when the body reaches a second temperature. The second color provides a visual alert for a fault between the first electrical device and the second electrical device.

According to another aspect of various embodiments of the present disclosure, there is provided a method including preparing and applying a thermal indicating coating(s) to at least one surface of a connector.

According to another aspect of various embodiments of the present disclosure, there is provided a method of calibrating an electric bushing by measuring temperatures at various locations along a body of the bushing; comparing the measured temperatures to known thresholds of a thermochromic paint; and applying the thermochromic paint to a surface of the bushing where the measured temperature matches the known threshold.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects and advantageous features of the present disclosure will become more apparent to those of ordinary skill when described in the detailed description of preferred embodiments and reference to the accompany drawing wherein:

FIG. 1 shows a perspective view of an electrical power system.

FIG. 2 shows a bushing used in the electrical power system of FIG. 1 where a portion of the bushing includes a thermochromic paint exhibiting a first color.

FIG. 3 shows the bushing of FIG. 2 with the thermochromic paint exhibiting a second color.

FIG. 4 shows the bushing of FIG. 2 with the thermochromic paint exhibiting a third color.

FIG. 5 shows the bushing of FIG. 2 with the thermochromic paint exhibiting a fourth color.

FIG. 6 shows a front view of a first connector used with an electrical power system where a portion of the first connector includes a thermochromic paint exhibiting a first color.

FIG. 7 shows a front view of a second connector used with an electrical power system where a portion of the second connector includes a thermochromic paint exhibiting a first color.

FIG. 8 shows a schematic view of an alternate example of a bushing used with the power system of FIG. 1, where the bushing includes a sensor and an output device that can communicate with an external device.

FIG. 9 shows a flow diagram illustrating a calibration process.

### DETAILED DESCRIPTION

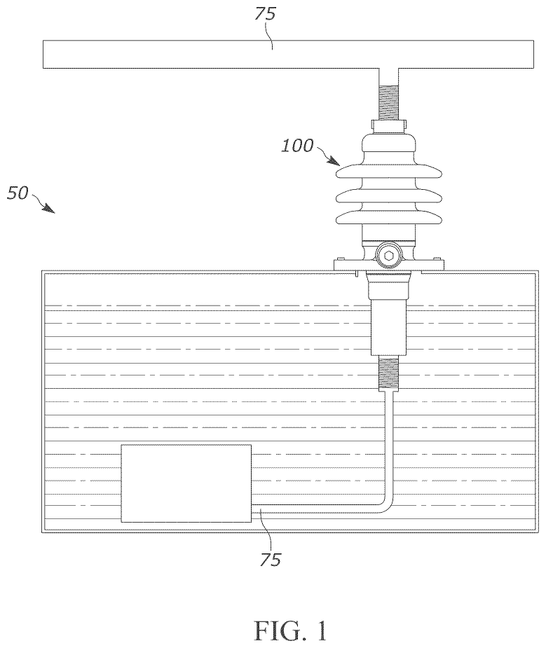

As shown in FIG. 1, an electrical system or power system 50 may be used to high electrical voltages (e.g., 1000 kV). The power system 50 includes different electrical components 75 (e.g., transformers), which can be connected together using one or more connectors 100 (e.g., bushings).

Bushings 100 typically fit around at least a portion of other electrical components 75. The connection (e.g., a threaded connection) between a bushing 100 and an electrical component 75 is typically not be visually apparent to a person (e.g., the connection may be covered by a connector).

To assist in providing a way to visually inspect the connection, the bushing 100 may be manufactured to provide an alert to a person that the connection is faulty or otherwise should be inspected. The illustrated example of the bushing 100 includes a visual alert, although other bushings 100 may include other alerts (e.g., auditory, electronic, etc.).

In one form, a thermal-activated material may be applied to at least one surface of the bushing 100. The material may provide a visual indication upon reaching a particular temperature threshold. The surface that the material is applied to may be an external surface of the bushing 100 so that it is visible to a person remote from the bushing 100.

In certain forms, the thermal-activated material may be a thermochromic paint or a thermochromic coating that is applied to the bushing 100. The thermochromic paint or thermochromic coating may be applied to the entire external surface of the bushing 100, although in other examples only some portions of the external surface may include the thermochromic paint or thermochromic coating. The thermochromic paint or thermochromic coating may melt or undergo other chemical changes to change colors based on the application and/or removal of heat. As described in more detail below, changes in color of the paint or coating may be irreversible or reversible depending on its purpose.

In one form, the thermochromic paint or thermochromic coating may be applied to at least a portion of an inner surface of the bushing 100 (e.g., in addition to or instead of the outer surface). The thermochromic paint or thermochromic coating may also be applied to at least a portion of one or more electrical components 75 in the power system 50.

In some forms, the thermochromic paint or thermochromic coating may have a first color when it is initially applied to the selected surface of the bushing 100 (or other element). For example, the thermochromic paint or thermochromic coating may be stored and/or applied at room temperature (e.g., less than 40° C.). At this temperature, the thermochromic paint or thermochromic coating may include the first temperature that is not visually indicative of an improper connection.

For example, the thermochromic paint or thermochromic coating may include a clear or neutral color (e.g., white, gray, beige, brown, silver, black, etc.). The color may not visually contrast from other elements in the power system 50, so that a person's eyes are not drawn to bushing 100 in a normal condition and the alert color stands out.

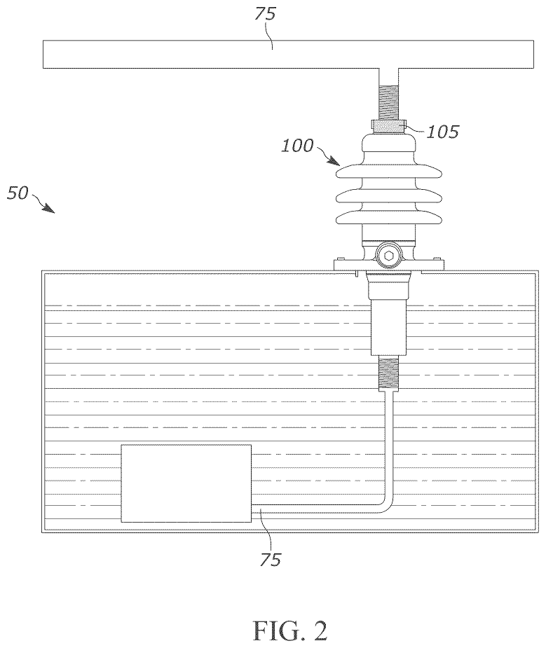

The thermochromic paint or thermochromic coating may also include another color (e.g., pink-see 105 in FIG. 2) which may be visually stimulating in a non-alert condition. The first color may stand out so that a person can more clearly find the bushing 100 and determine if color has changed. As described in more detail below, the additional colors may also stand out and be visually contrasted from the visually stimulating first color.

In certain forms, an outer coating (e.g., a protective coating) may be applied to the bushing 100 after the thermochromic paint or thermochromic coating is first applied. The outer coating may be substantially clear and does not obstruct the visual inspection of the thermochromic paint or thermochromic coating. The outer coating may assist in reducing weathering of the thermochromic paint or thermochromic coating. The outer coating may also provide UV protection for the thermochromic paint or thermochromic coating.

In some forms, the thermochromic paint or thermochromic coating may change colors from the first color to one or more other colors. These other colors (e.g., a second color, a third color, etc.) may provide visual alerts to people. As described in more detail below, the different colors may communicate different alerts.

As shown in FIG. 2, the thermochromic paint or thermochromic coating is applied to the bushing 100. Only a portion of the bushing 100 is covered with the paint to visually indicate that it includes a different color than the material of the bushing 100. However, as described above, any portion or the entire surface may be covered with the thermochromic paint or thermochromic coating.

The paint may include the first color, which represents an initial or base color. The paint may remain at this color while the surface of the bushing 100 remains below a first temperature threshold or within a first temperature range. In this state, the color of the bushing 100 may be visually stimulating so that the part is identifiable, and a person can more easily locate the part to determine if any color change occurred.

The first threshold may be a transition point between the paint having the first color and the second color. In some forms, the paint remains with the first color when the temperature of the bushing 100 is less than about 150° C. In some forms, the paint remains with the first color when the temperature of the bushing 100 is less than about 130° C. In some forms, the paint remains with the first color when the temperature of the bushing 100 is less than about 115° C. In some forms, the paint remains with the first color when the temperature of the bushing 100 is less than about 100° C. In some forms, the paint remains with the first color when the temperature of the bushing 100 is less than about 50° C.

In some forms, the paint remains with the first color when the temperature of the bushing 100 is between about −100° C. to about 200° C. In some forms, the paint remains with the first color when the temperature of the bushing 100 is between about-50° C. to about 150° C. In some forms, the paint remains with the first color when the temperature of the bushing 100 is between about −50° C. to about 115° C. In some forms, the paint remains with the first color when the temperature of the bushing 100 is between about −50° C. to about 100° C. In some forms, the paint remains with the first color when the temperature of the bushing 100 is between about −50° C. to about 50° C. In some forms, the paint remains with the first color when the temperature of the bushing 100 is between about −50° C. to about 40° C. In some forms, the paint remains with the first color when the temperature of the bushing 100 is between about 0° C. to about 40° C.

Although a lower range is indicated, the paint may be intended to react with warmer temperatures (e.g., when the temperature exceeds a particular range). The description below specifically references color changes when the temperature of the bushing 100 increases. However, other examples of the paint may change colors and provide similar alerts when the temperature falls below a predetermined threshold or below the predetermined range. The upper value in the above-described ranges may similarly be a first threshold above which the temperature of the paint changes.

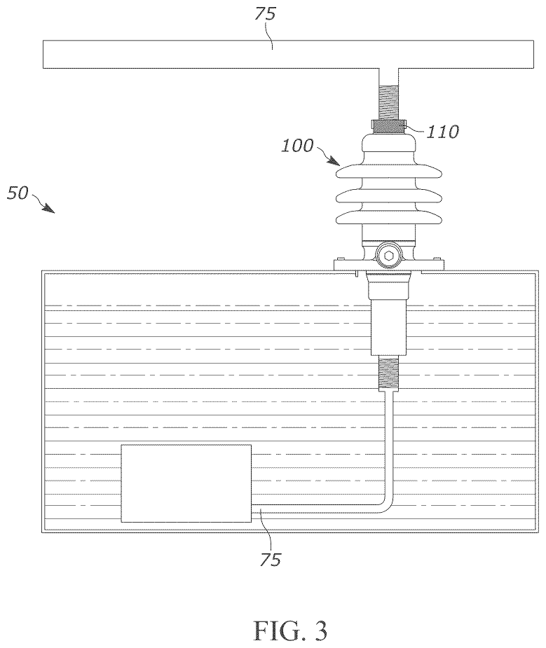

When the temperature of the paint (e.g., the surface of the bushing 100 that includes the paint) exceeds the first threshold, the paint may change from a first color to a second color. The second color may be visually distinct from the first color. For example, FIG. 3 shows that the second color is red 110 and thus visually different than the pink 105 shown in FIG. 2.

In some forms, the color of the paint may change gradually as the temperature exceeds the first threshold. For example, the color may not immediately shift from the first color to the second color and may instead gradually transition between the two. The paint may slowly transition to toward the second color as the temperature approaches the first threshold from below and may become more prominently the second color as the temperature exceeds the first threshold. The first threshold of the illustrated paint may be about 115° C., but as described above, the first threshold may be any number of temperatures.

In certain forms, the change between the first color and the second color may be gradual such that it occurs over a duration of time. For example, it may take between about one minute and about one day for the first color to change to the second color. For example, it may take between about one minute and about 12 hours for the first color to change to the second color. For example, it may take between about one minute and about four hours for the first color to change to the second color. For example, it may take between about five minutes and about two hours for the first color to change to the second color. For example, it may take between about ten minutes and about one hours for the first color to change to the second color. For example, it may take between about 15 minute and about 45 minutes for the first color to change to the second color. For example, it may take between about 25 minute and about 35 minutes for the first color to change to the second color. For example, it may about 30 minutes for the first color to change to the second color.

The paint may maintain the second color after exceeding the first threshold (e.g., and prior to exceeding any subsequent thresholds). In some forms, the change between the first and second color may be permanent or irreversible. In other words, the paint may be unable to return to the first color (see e.g., FIG. 2) after reaching the second color (see e.g., FIG. 3). This may, the visual alert may remain even if the temperature later falls below the first threshold. A person who inspects the bushing 100 after the temperature falls below the first threshold can still determine that the temperature exceeded the first threshold and may take further action if necessary (described below).

In other examples, the color change may not be permanent (i.e., is reversible), and the paint may be able to return to the first color after the temperature falls below the first threshold. The bushing 100 may be visually inspectable while above the first threshold, but it may not be visually apparent that the temperature was previously above the first threshold after it falls below the first threshold. The power system 50 may include an element that permits detection of the color change to the second color so that a person not presently observing the color change can later confirm the color change if the temperature falls below the first threshold. This element may be a photosensor that communicates remotely with an electronic device (e.g., a computer, a smartphone, etc.) and/or a camera.

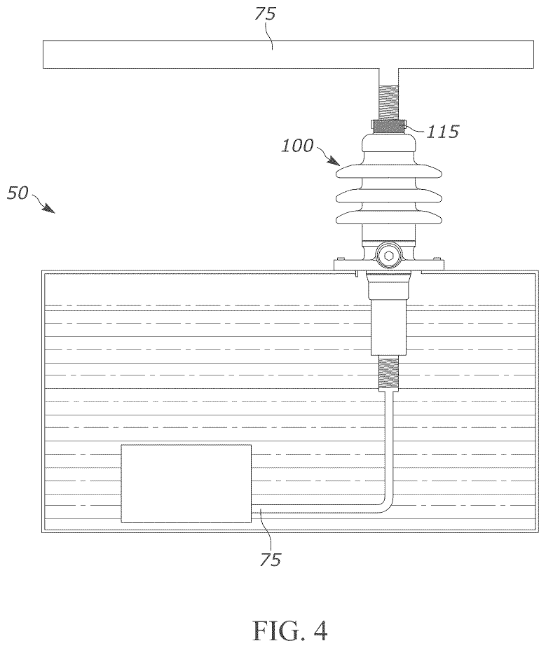

In some forms, the paint may remain at the second color (see e.g., FIG. 4) while the temperature of the bushing 100 is within a second range. For example, the second range may be between about −50° C. to about 250° C. The second range may be between about 0° C. to about 200° C. The second range may be between about 100° C. to about 150° C. The second range may be between about 115° C. to about 145° C.

As the temperature of the paint approaches the upper end of the second range (e.g., a second threshold), the paint may behave in a similar manner as when the temperature increased toward the first threshold. Accordingly, only some similarities and differences are described below.

In some forms, the color of the paint may change gradually as the temperature exceeds the second threshold. For example, the color may not immediately shift from the second color to a third color and may instead gradually transition between the two. The paint may slowly transition to toward the third color as the temperature approaches the second threshold from below and may become more prominently the third color as the temperature exceeds the second threshold. The second threshold of the illustrated paint may be about 145° C., but as described above, the second threshold may be any number of temperatures.

In certain forms, the change between the second color and the third color may be gradual such that it occurs over a duration of time. For example, it may take between about one minute and about one day for the second color to change to the third color. For example, it may take between about one minute and about 12 hours for the second color to change to the third color. For example, it may take between about one minute and about four hours for the second color to change to the third color. For example, it may take between about five minutes and about two hours for the second color to change to the third color. For example, it may take between about ten minutes and about one hours for the second color to change to the third color. For example, it may take between about 15 minute and about 45 minutes for the second color to change to the third color. For example, it may take between about 25 minute and about 35 minutes for the second color to change to the third color. For example, it may about 30 minutes for the second color to change to the third color.

As described with the transition between the first and second colors, the transition between the second color (see e.g., red 110 in FIG. 3) and the third color (see e.g., light purple 115 in FIG. 4) may be permanent or irreversible (e.g., such that when the second threshold is exceeded, the paint does not return to the second color) or may be temporary or reversible (e.g., the paint returns to the second color if the temperature drops below the second threshold).

In certain forms, one color change may be permanent or irreversible while another color change may be temporary or reversible. For example, the change of color when the temperature exceeds the first threshold may be permanent (e.g., so a person not currently observing the bushing 100 can later observe that the first threshold was exceeded) and the change in color when the temperature exceeds the second threshold may be temporary.

As shown in FIG. 4, the third color may be more visually different from the second color (e.g., light purple 115 to red 110) than the second color from the first color (e.g., red 110 to pink 105). The third color may appear more prominently than the second color and may provide a more prominent alert. For example, alerts signaled by the first and second colors may be similar because the color is similar, but the alert signified by the third color may be different. This can signify a condition that requires more immediate attention, (although as described below, alerts can have different meanings).

In other forms, the third color may be another different than the second color (e.g., blue and red, or any other combination of different colors or shades of colors). Using different colors may provide visually stimulating differentiators for different types of alerts.

In still other forms, the third color may be a different shade (e.g., lighter or darker) than the first color and/or the second color. Using a similar color may be used to signify a similar alert or may be used because the color is visually stimulating (e.g., compared to the environment and other components).

In some forms, the paint may remain at the third color while the temperature of the bushing 100 is within a third range. For example, the third range may be between about −50° C. to about 350° C. The second range may be between about 0° C. to about 300° C. The second range may be between about 120° C. to about 200° C. The second range may be between about 145° C. to about 195° C.

As the temperature of the paint approaches the upper end of the third range (e.g., a third threshold), the paint may behave in a similar manner as when the temperature increased toward the first or second thresholds. Accordingly, only some similarities and differences are described below.

In some forms, the color of the paint may change gradually as the temperature exceeds the third threshold. For example, the color may not immediately shift from the third color to a fourth color and may instead gradually transition between the two. The paint may slowly transition to toward the fourth color as the temperature approaches the third threshold from below and may become more prominently the fourth color as the temperature exceeds the third threshold. The third threshold of the illustrated paint may be about 195° C., but as described above, the third threshold may be any number of temperatures.

In certain forms, the change between the third color and the fourth color may be gradual such that it occurs over a duration of time. For example, it may take between about one minute and about one day for the third color to change to the fourth color. For example, it may take between about one minute and about 12 hours for the third color to change to the fourth color. For example, it may take between about one minute and about four hours for the third color to change to the fourth color. For example, it may take between about five minutes and about two hours for the third color to change to the fourth color. For example, it may take between about ten minutes and about one hours for the third color to change to the fourth color. For example, it may take between about 15 minute and about 45 minutes for the third color to change to the fourth color. For example, it may take between about 25 minute and about 35 minutes for the third color to change to the fourth color. For example, it may about 30 minutes for the third color to change to the fourth color.

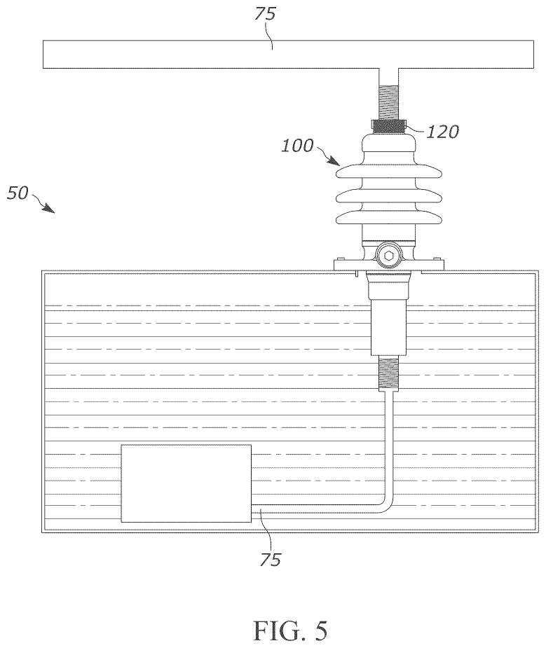

As described with the transition between the first and second colors, the transition between the third color (see e.g., light purple 115 in FIG. 4) and the fourth color (see e.g., dark purple 120 in FIG. 5) may be permanent or irreversible (e.g., such that when the third threshold is exceeded, the paint does not return to the third color) or may be temporary or reversible (e.g., the paint returns to the third color if the temperature drops below the third threshold).

In certain forms, one color change may be permanent while another color change may be temporary. For example, the change of color when the temperature exceeds the first threshold may be permanent (e.g., so a person not currently observing the bushing 100 can later observe that the first threshold was exceeded) and the change in color when the temperature exceeds the third threshold may be temporary (as with exceeding the second threshold described above).

As shown in FIG. 5, the fourth color may be similar to the second and/or third colors. In the illustrated example, the fourth color may be darker (e.g., include more shade) than the third color. The illustrated color may be a darker shade of purple but may also be more similar to the at least the third color (e.g., light purple 115). The darker fourth color may appear more prominently than the lighter third color and may provide a more prominent alert. In other words, the darker color may provide greater visual contrast so that it stands out more than the third color. This can signify a condition that requires more immediate attention, (although as described below, alerts can have different meanings).

In other forms, the fourth color may be different than the second and/or the third colors (e.g., blue, red, and green, or any other combination of different colors or shades of colors). Using different colors may provide visually stimulating differentiators for different types of alerts.

In some forms, the different temperature thresholds (e.g., the first, second, and third thresholds) may be indicative of different conditions in the system. In other words, communicating that the bushing 100 exceeded any one of the temperature thresholds may provide an observer with information about the system.

For example, the temperature thresholds may be used to alert people to potential faults in the system. Higher temperatures may be indicative of a bushing 100 that is improperly connected. Heat may be generated as a result of the improper connection. Hotter temperatures may be indicative of a more serious improper connection and/or a bushing 100 that has been improperly connected for an extended period of time.

Although the above examples describe the paint changing colors based on exceeding thresholds of higher temperatures, the paint could also change colors when a temperature falls below lower temperature thresholds (e.g., to alert to cold conditions that could result in failure). In other words, each successive temperature threshold may have a lower temperature than the preceding temperature threshold (e.g., the temperature at the third threshold is colder than the temperature at the second threshold). Although the above-described description relates to thresholds with increasing temperatures, the description may be similarly applicable to thresholds with decreasing temperatures. Only some similarities and differences of decreasing temperature thresholds may be described below.

In some forms, the paint may include a color for a neutral temperature (e.g., ambient temperature in the first range) and may change colors as the temperature of the bushing 100 changes (e.g., either increases or decreases in temperature).

In certain forms, the change in color may be irreversible so that although the paint can initially detect higher or lower changes in temperature, the paint may be only able to alert to only higher or lower changes based on an initial change (e.g., can only alert to exceeding higher thresholds if the first threshold is a higher temperature). In other forms, the change in color may be reversible so that the paint can alert to passing a threshold in either direction. Like with the paint that alerts when exceeding higher temperature thresholds, changing colors after falling below lower temperature thresholds may provide similar alerts that may be understood by a technical to assess the status of the bushing 100.

In some forms, exceeding the first temperature threshold (e.g., about 115° C.) may be indicative that the bushing 100 connection is improper. While the temperature remains in the second temperature range (e.g., between the first and second thresholds), the power system 50 may be operating at less-than-optimal conditions and the alert produced by the second color (see e.g., FIG. 3) may indicate that the bushing 100 should be adjusted or replaced. If the temperature continues to increase and it exceeds the second threshold (e.g., about 145° C.), the power system 50 may be performing even worse and more immediate action may be needed. In one example, the paint changing to the third color (see e.g., FIG. 4) may indicate not only that the bushing 100 should be replaced or adjusted but may indicate more urgency to make the adjustment. If the temperature increases even further and exceeds the third threshold (e.g., about 195° C.), the alert produced by the paint changing to the fourth color (see e.g., FIG. 5) may indicate that the power system 50 could imminently fail and that a person must take immediate action (e.g., shut down the system to adjust or replace the bushing 100). The alert produced by changing from the third color to the fourth color may also or alternatively indicate that partial discharge or arcing has occurred or will soon occur in the power system 50.

A person viewing the bushing 100 in the power system 50 may be able to see the alert and based on the color of the paint, be able to determine an appropriate course of action. This may alert a technician to a specific location of a problem in the system 50 and minimize guesswork in repairing the system.

In other forms, the thresholds may be calibrated differently (e.g., a different type of paint is used) so that the color changes upon exceeding these thresholds communicates different information. For example, one or more of the thresholds may be lower and/or one or more of the temperature ranges may be larger. In this example, the alerts may be indicative of a maintenance schedule instead of potential failure conditions.

For example, the connection of the bushing 100 may deteriorate over time, which may cause the temperature in the bushing 100 to increase. This increase may exceed a typical operating temperature, but it may not reach the temperature of the above described first threshold (e.g., about 115° C.). Based on prior data collected about failure in bushings 100 (or other components), the system 50 may be calibrated with the paint to alert for estimated times until service.

In certain forms, the colors of the paint may signify communicate a length of time until service is needed based on a relationship of the temperature of the bushing 100 and a length of time until failure. For example, each color may represent an estimated period of time (e.g., days, weeks, months, etc.) until the bushing 100 needs to be replaced. This may be estimated based on quantifying the rate of temperature increase and a known maximum temperature that the bushing 100 can withstand.

In still other forms, the change in color of the paint may indicate changes in conditions other than temperature. For example, the paint may undergo reversible changes based on a current and/or voltage passing through. The paint may changes colors based on an increase in voltage an/or current and/or a decrease on the voltage and/or current. The changes may indicate an improper electrical connection and may indicate an urgency with which to service the power system 50.

In some forms, a camera may be positioned proximate to the bushing 100 to remotely monitor the color of the bushing 100. For example, the camera may provide a visual indication of the color of the bushing 100 without requiring a human to directly view the bushing 100. The camera may provide continuous video monitoring, may take images at a predetermined interval, and/or may take images or record when a change in color is detected.

In some forms, the camera may be used with a sensor (e.g.,—photosensor 175, described below) to provide an electronic alert than can encourage a technician to check the photos or videos from the camera to determine what color change occurred (e.g., what threshold was exceeded).

As indicated above, there may be other forms of alerts (e.g., non-visual alerts) that may be used in addition to or instead of a visual alert. These other types of alerts may provide other ways to communicate conditions of the bushing 100.

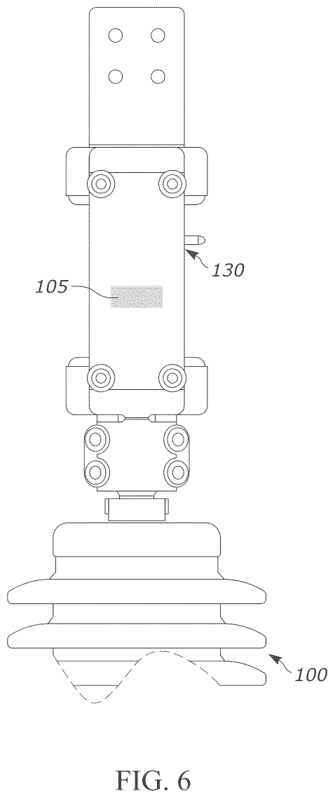

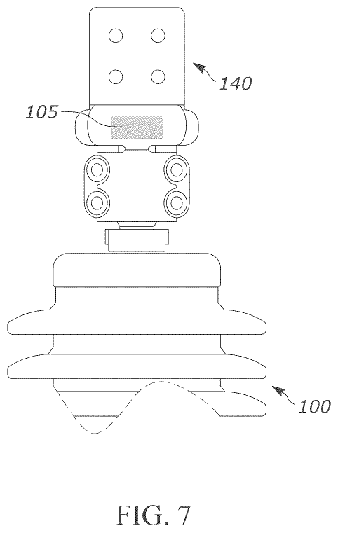

As shown in FIGS. 6 and 7, the thermochromic paint or thermochromic coating may be applied to other surfaces besides the bushing 100. For example, a connector may be coupled to the bushing 100 or another portion of the power system 50. FIG. 6 shows illustrates a first connector 130 and FIG. 7 illustrates a second connector 140, although any other type of connector may be used. The paint or coating applied to the connectors 130, 140 may work in substantially the same way as described above. For example, the paint may transition to a first color 105 (e.g., pink) when the temperature rises above a first threshold. The paint may continue to change colors as a temperature continues to change (see e.g., FIGS. 2 to 5). In some forms, the temperature thresholds and paint colors may be the same for the connectors 130, 140 and the bushings 100. In other forms, a separate paint may be used for the connectors 130, 140 so that the color and/or the temperature thresholds are different.

In some forms, the first and second connectors 130, 140 may not be bushings (e.g., bushing 100), but may similarly referred to as a connector because they connect two or more elements together. Like the bushing 100, the first and second connectors 130, 140 may undergo thermal changes because of the contact with other elements of the power system 50.

In still other forms, the connector may refer to other elements in the power system 50. For example, the thermochromic paint may be applied to a conductor (e.g., that extends between a circuit breaker and an overhead power line) in the manner described above. A person of ordinary skill in the art would understand that the thermochromic paint could be applied to any element within the power system 50 to provide a technician with an indication of a temperature change on that element. Other elements within the power system 50 that include a thermochromic paint may or may not be directly coupled to the bushing 100.

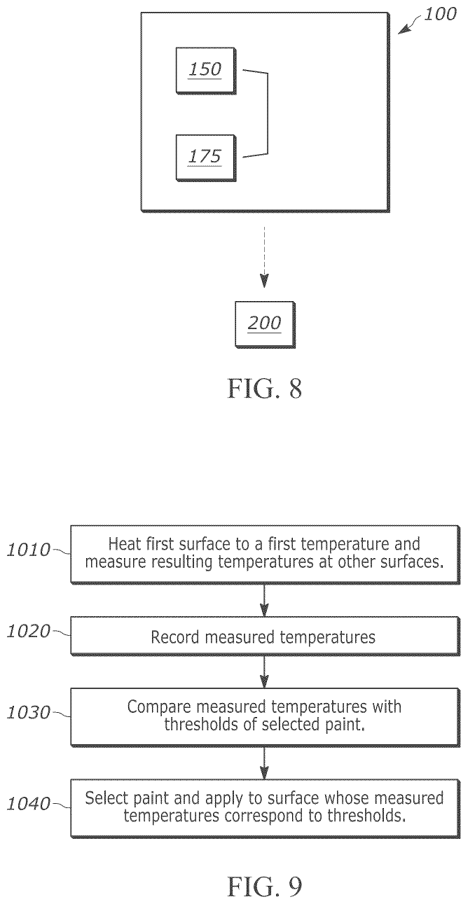

As shown in FIG. 8, an output device 150 may be connected to the bushing 100 that can communicate an alert. The output device 150 may be a transponder that can wirelessly communicate (e.g., via radio waves, Wi-Fi, cellular networks, Bluetooth, etc.) with an external device 200 (e.g., a remote computer). The output device 150 may also be a speaker that outputs an auditory signal.

The paint may react with the output device 150 so that changes in the paint cause the output device 150 to output a signal. For example, a photosensor 175 may be connected to the output device 150. The photosensor 175 may detect changes in the color of the paint and may communicate those changes to the output device 150, which may then output a signal based on the alert communicated by the specific color.

For example, a transponder may send a signal to the external device, which may show a temperature range and time stamp for a particular bushing 100. Technicians can remotely monitor the power system 50 and conduct maintenance based on the signal received.

In another example, the speaker may output a sound based on the temperature exceeding a threshold. The sound may be the same for each threshold and may simply provide an additional alert for a technician to view the change in color. The sound may also be different (e.g., a different tone, a different pattern, etc.) and may provide a complementary alert to the visual alert from the paint.

In yet another example, the output device 150 may output a signal based on transformations undergone by the paint. For example, the paint may melt when one or more of the temperature thresholds are exceeded. The output device 150 may be positioned in the paint and unable to send or receive signals until the paint melts. The melting paint may activate the output device 150 (e.g., by partially freeing it from the paint and enabling a connection) and permit it to output a signal (e.g., a wireless communication to an external device).

In another form, the bushing 100 (or other component) may include a sensor (e.g., a thermistor). The sensor may produce a separate alert from the paint. In other words, the sensor reading may not be dependent on whether the paint changes colors. The sensor may communicate the signal to an external device to allow for remote monitoring.

In another form, the bushing 100 may be coated with a substance that will melt at a temperature that would indicate an inappropriate temperature is occurring at that surface. The substance may be different that the paint and may be used instead of or in addition to the paint. The melting of the substance may produce a visual change that is different than a color change.

Because the connection is internal to the bushing 100, the relevant temperature may be within the bushing 100. Although the internal portions of the bushing 100 may include the paint, these areas may not be readily visible for inspection. The bushing 100 may be formed from a thermally conductive material so that heat from within the bushing 100 transfers to external surfaces of the bushing 100.

As shown in FIG. 9, the power system 50 may be calibrated so that the alerts correspond to relevant temperatures on a particular surface. For example, the paint, and therefore the color change, may occur on one surface, but will communicate an alert (e.g., the temperature) on another surface.

For example, thermal testing may be run on the bushing 100 using thermocouples or other sensors. These sensors may determine different temperatures along different locations of the bushing 100. As described in step 1010, a particular surface may be heated (or cooled) to a predetermined temperature. This temperature may correspond to the temperature at which an alert may be necessary. For example, an inner surface of the bushing 100 may be heated to a known temperature. Sensors may be placed at other surfaces to record the corresponding temperature at that surface.

These temperatures can be sorted and recorded (e.g., in a database) 1020 so that a measured temperature at one surface corresponds to the simultaneously measured temperatures at other surfaces. Based on this information, technicians form a heating model for the bushing 100 at various conditions. For example, the model can show the temperature along various locations of the bushing for various failure modes. In other words, at each known temperature that the bushing 100 was heated to, the model shows the corresponding temperatures at other surfaces. Using this temperature data, a paint can be selected with appropriate thresholds based on these conditions (e.g., the paint may be selected to change color in a temperature range that is consistent with a failure in the bushing 100). In other words, a paint with certain thresholds can be compared 1030 to the data and a technician can select 1040 a surface to apply the paint based on a comparison of the paint's temperature thresholds and the measured data.

The paint therefore may be calibrated (e.g., produced with specific thresholds) so that the external alerts (e.g., color changes) can be used to approximate the internal temperatures. For example, by knowing the external thresholds and rate of heat transfer, a technician can approximate the internal temperatures.

The paint may be produced so that the threshold temperatures at an external surface correspond to the desired temperatures that occur within the bushing 100. For example, the technician may desire to apply the paint to a particular surface (e.g., because it is easier to observe). The technician may select a paint or modify an existing paint so that the threshold values of the paint match the temperature values of the desired surface.

It may be important to calibrate the paint to determine the relevant temperature of the bushing more accurately 100. For example, this may limit alerts that occur too late and can permit earlier detection (e.g., if the external temperature is less than the internal temperature so that there is a delay between when the bushing 100 exceeds a threshold and when the paint begins the process of changing colors).

Although FIG. 9 describes heating the bushing 100 to a predetermined temperature, the description is equally applicable to creating a temperature profile and selecting a paint to alert at colder temperatures.

The paint may be calibrated to select specific thresholds by incorporating thermal models to create a heating model of the bushing 100. Additional thresholds and color changes may be included to provide various factors of safety or include other information. As described above, changing color at a lower threshold may provide a warning while changing color at a higher threshold may indicate failure has occurred. Creating the heating model enables a technician to more accurately relate the temperature where failure occurs (e.g., internal to the bushing 100) to the temperature of visible surface of the bushing 100 (e.g., an external surface).

Although the above description focuses on a bushing 100, the paint may be applied to a surface of any component (e.g., a connector) in a power system 50 (or in any other type of system). For example, the paint could also be applied to a test terminal, like what is described in U.S. Pat. No. 8,525,526, the entire contents of which is incorporated by reference herein in its entirety. Paint may be applied to these other surfaces to determine the temperature in the particular element and/or the surface may be calibrated to determine the temperature in another element (e.g., in the bushing 100).

For example, sensors may be positioned on the bushing 100 and on a test terminal. The system may be calibrated by comparing critical temperatures on the bushing 100 to corresponding temperatures on the test terminal (or vice versa). The paint may be applied to the test terminal (e.g., because it is easier to see than the bushing 100) and color changes on the test terminal may communicate the condition of the bushing 100.

The other element could also be connected to the bushing 100 while forming the temperature profile described in FIG. 9. For example, after applying a known temperature to the bushing, the measuring 1010 and recording 1020 steps could take place at the other element so that the paint thresholds were compared 1030 to values on an element besides the bushing 100.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. An electrical bushing for providing an alert to a system condition, the bushing comprising:
a body having an internal surface configured to receive an electrical device and an external surface; and
a thermochromic paint applied to the external surface;
wherein the thermochromic paint includes a first color at a first temperature and is configured to change to a second color when the body reaches a second temperature; and
wherein the second color provides a visual alert for a fault in the body.

2. The electrical bushing of claim 1, wherein thermochromic paint is configured to undergo an irreversible change between the first color and the second color.

3. The electrical bushing of claim 1, wherein thermochromic paint is configured to undergo a reversible change between the first color and the second color.

4. The electrical bushing of claim 1, further comprising a coating applied to the body that is configured to protect the thermochromic paint from weathering.

5. The electrical bushing of claim 1, wherein a threshold of the thermochromic paint between the first temperature and the second temperature is calibrated to indicate a temperature occurring at the external surface.

6. The electrical bushing of claim 1, wherein a threshold of the thermochromic paint between the first temperature and the second temperature is calibrated to indicate a temperature occurring at the internal surface.

7. The electrical bushing of claim 1, wherein the thermochromic paint is configured to change to a third color when the body reaches a third temperature; wherein the third temperature is greater than the second temperature and the third color is different than the second color.

8. The electrical bushing of claim 1, wherein the thermochromic paint is further applied to the internal surface.

9. The electrical bushing of claim 1, wherein a threshold of the thermochromic paint between the first temperature and the second temperature is calibrated to indicate a temperature occurring at a distant surface from the paint application region.

10. The electrical bushing of claim 1, further comprising a photosensor configured to sense the change between the first color and the second color, wherein the photosensor is configured to transmit an electronic alert to a remote device.

11. A power system comprising:
a first electrical device;
a second electrical device; and
a connector coupling the first electrical device to the second electrical device, the connector including:
a body having an internal surface configured to receive an electrical device and an external surface; and
a thermochromic paint applied to the external surface;
wherein the thermochromic paint includes a first color at a first temperature and is configured to change to a second color when the body reaches a second temperature; and
wherein the second color provides a visual alert for a fault between the first electrical device and the second electrical device.

12. (canceled)

13. (canceled)

14. The power system of claim 11, further comprising a coating applied to the body that is configured to protect the thermochromic paint from weathering.

15. (canceled)

16. (canceled)

17. The power system of claim 11, wherein the thermochromic paint is configured to change to a third color when the body reaches a third temperature; wherein the third temperature is greater than the second temperature and the third color is different than the second color.

18. (canceled)

19. (canceled)

20. The power system of claim 11, further comprising a substance applied to the external surface, the substance is configured to melt at a third temperature to provides an alert for a fault between the first electrical device and the second electrical device.

21. The power system of claim 11, wherein the connector is a bushing.

22. An electrical connector for providing an alert to a system condition, the electrical connector comprising:
a body configured to be coupled to an electrical device; and
a thermochromic paint applied to a surface of the body;
wherein the thermochromic paint includes a first color at a first temperature and is configured to change to a second color when the body reaches a second temperature; and
wherein the second color provides a visual alert for a fault in the body.

23. (canceled)

24. (canceled)

25. (canceled)

26. The electrical connector of claim 22, wherein a threshold of the thermochromic paint between the first temperature and the second temperature is calibrated to indicate a temperature occurring at an external surface of the body.

27. The electrical connector of claim 22, wherein a threshold of the thermochromic paint between the first temperature and the second temperature is calibrated to indicate a temperature occurring at an internal surface of the body, wherein the internal surface is configured to receive the electrical device.

28. (canceled)

29. (canceled)

30. (canceled)

31. The electrical connector of claim 22, further comprising a photosensor configured to sense the change between the first color and the second color, wherein the photosensor is configured to transmit an electronic alert to a remote device.

32. The electrical connector of claim 22, wherein the connector is a bushing.
